(19) United States
(12) Patent Application Publication
(10) Pub. No.: US 2011/0095939 A1
(43) Pub. Date: Apr. 28, 2011

(54) PROCESS AND SYSTEM FOR DETERMINING THE POSITION AND VELOCITY OF AN OBJECT

(75) Inventors: Peter Martin, Chelmsford, Essex (GB); Adam Bryce Maclean, Chelmsford Essex (GB)

(73) Assignee: BAE SYSTEMS PLC, London (GB)

(21) Appl. No.: 12/995,594

(22) PCT Filed: Jun. 9, 2009
(86) PCT No.: PCT/GB09/50641

§ 371 Date: Dec. 1, 2010

(30) Foreign Application Priority Data
Jun. 13, 2008 (GB) 0810860.7

(51) Int. Cl. G01S 13/42; G01S 15/42

(52) U.S. Cl. 342/109; 367/89

(57) ABSTRACT

A process for determining the position and velocity of an object is disclosed. The process comprises: -generating a first burst of pulses at a first pulse repetition frequency and subsequently receiving a first set of signals characteristic of the range and velocity of the object; -generating a second burst of pulses at a second pulse repetition frequency and subsequently receiving a second set of signals characteristic of range and velocity of the object; -generating a first data set representative of range and corresponding velocity values from the first set of signals; -generating a second data set representative of range and corresponding velocity values from the second set of signals; -summing a magnitude of a signal strength from each of the first and second data sets at corresponding range and velocity values; and, -comparing the magnitude of the summed signal strengths to a threshold value.

The present invention relates to a process and a system for determining the position and velocity of an object and particularly, but not exclusively to a RADAR system for tracking an object in space.

RADAR (RAdio Detection And Ranging) is a process which relies upon the reflection of radio waves from an object, such as an aircraft. The radio waves are transmitted from a RADAR transmitter and the time interval between their transmission and reception at the RADAR receiver is monitored to determine the distance of the object from the RADAR. By coordinating this measurement with the elevated and azimuthal directions of the transmitted signal, it is possible to determine the position of the object with respect to the RADAR and to track the position of the object in space.

The signal transmitted by the RADAR is typically sent as a continual train of periodic packets of pulses. The pulses help to build up a discernible “echo” from the object by summing the reflected “echo” from each transmitted pulse so as to reinforce the return signal. However, echoes from objects must be detected and processed before the next pulse of the train of pulses is transmitted if so-called range ambiguity is to be avoided. Range ambiguity occurs when the time taken for the reflected signal to return to the RADAR receiver system is greater than the pulse repetition time (PRT) or period. If the reflected signal arrives back at the receiver system after the next pulse is transmitted, then that reflected signal would appear to be derived from said next pulse and thus appear to come from an object closer than in reality. In this case, the reflected signal is said to exist in the second ambiguity. Similarly, if the reflected pulse is received after the second subsequent pulse is transmitted, then the reflected pulse is said to exist in the third ambiguity.

For example, use of a pulse repetition frequency (PRF) of 7.5 kHz will return unambiguous reflected signals from about 20 km. If the PRF was doubled however, to 15 kHz then the unambiguous range is reduced to 10 km and so objects beyond this range would appear on the display system after the next pulse has been transmitted. An object at 12 km for example, would appear to be at an ambiguous range of 2 km, namely within the second ambiguity, although the strength of the reflected signal would be much lower than from a genuine object at 2 km.

However, long PRT consume RADAR time which compromises the performance of other functionality, such as the determination of the velocity of an object.

Basic Fourier analysis enables any periodic function, e.g. a train of periodic pulses, to be decomposed into a sum of harmonic sinusoidal waves each with a particular frequency. Accordingly, a pulse train transmitted from a RADAR transmitter can be broken down into a series of independent frequency components using Fourier Transforms.

Pulsed Doppler systems rely upon the frequency shift between the transmitted pulse and the reflected pulse to determine the velocity of an object. In this respect, there must be a net radial velocity between the transmitter and the object. However, if the velocity of the object is sufficiently high, then the associated frequency shift, as measured from a particular Fourier frequency component within the transmitted spectrum, will be ambiguous. In this respect, it becomes difficult to associate the frequency shift of the reflected signal with the corresponding frequency component in the transmitted signal. This gives rise to so-called velocity ambiguity. For example, if the velocity of an object is such that the associated Doppler frequency shift produces a reflected signal having a frequency which is greater than the PRF, then the frequency shift can be mistakenly measured with respect to the PRF giving a lower than actual Doppler shift and thus an apparent slower velocity of the object. In this case, the velocity of the object is said to exist in the first velocity ambiguity. Moreover, and in contrast to range ambiguity, it is also possible for the object to have a negative velocity, for example, if the object moves away from the RADAR as opposed to moving toward the RADAR. In such cases, it is also possible for the velocity of the object to exist in a negative ambiguity.

Velocity ambiguity is a problem associated with pulse Doppler RADAR, since Doppler shifts crossing the PRF will be aliased. This problem can, however, be alleviated by increasing the PRF, which increases the spacing between adjacent frequency lines in the transmitted spectrum thereby allowing greater frequency shifts before aliasing occurs. For military RADAR intended to detect high speed closing objects, it is common for PRF of several hundred kilohertz to be employed. Accordingly, there is a trade-off between use of a lower PRF to minimise range ambiguity and a high PRF to minimise velocity ambiguity.

Having determined the ambiguous range and ambiguous velocity for a series of objects, it is possible to illustrate this data on a so-called range-velocity map, which is a plot of the ambiguous range against ambiguous velocity. The range and velocity of the series of objects are uncertain at this stage, accordingly, it is necessary to determine which ambiguity the reflected signal is derived from in order to determine the true or unambiguous range and velocity.

The range and velocity of objects and clutter are typically determined using one of two methods, which comprise the “power sum integration” method and the “binary integration” method. With the former, the signals reflected from objects travelling at a particular velocity at a particular range are summed and the result is then compared to a threshold to determine whether the reflected signal strength is above the levels of noise. However, as it is difficult to determine whether the reflected signals being summed are from the correct ambiguity, it is possible for objects to appear slower or faster than is actually the case, and also for objects to be missed completely.

In binary integration, the thresholding is performed on each burst of pulses and the results are then combined. In practice this system works by declaring a detection only if a fraction of the total number of bursts (for example, 2 out of 4 bursts of pulses) detect an object. This extra criterion for detection creates for a lower threshold value on the individual bursts for the same probability of false alarms and thus provides for increased detection.

Velocity is ordinarily determined by taking the individual ambiguous velocity from each burst and then determining which unambiguous velocity matches all of the ambiguous velocities using a process related to the Chinese Remainder Theorem. This relies on PRF being chosen so that the resolved velocities are not themselves ambiguous within the range of velocities of interest.

Power sum integration is generally better at integration, but because it does not have an ability to determine the velocity of an object, its use is limited.

We have now devised a process and system for determining the position and velocity of an object which alleviates the above mentioned problem.

In accordance with the present invention as seen from a first aspect, there is provided a process for determining the position and velocity of an object, the process comprising:
generating a first burst of pulses at a first pulse repetition frequency and subsequently receiving a first set of signals characteristic of the range and velocity of the object;
generating a second burst of pulses at a second pulse repetition frequency and subsequently receiving a second set of signals characteristic of range and velocity of the object;
generating a first data set representative of range and corresponding velocity values from the first set of signals;
generating a second data set representative of range and corresponding velocity values from the second set of signals;
summing a magnitude of a signal strength from each of the first and second data sets at corresponding range and velocity values; and,
comparing the magnitude of the summed signal strengths to a threshold value.

The process of the present invention provides for an improved signal-to-noise ratio over separate bursts to aid detectability of objects. It further provides the ability to unambiguously determine the location of objects in both range and velocity simultaneously. This reduces the problems of objects appearing closer than in reality and travelling at slower or faster speeds than in reality—a problem known as ghosting, whereby a target appears to be in an ambiguity where it is not really present. Moreover, since it performs this determination before determining the actual range and velocity of the target, it further provides for the ability to unambiguously detect objects that would not be detectable using only single bursts. In addition, the process provides for the ability to determine clutter (namely, unwanted reflections) locations in both range and velocity.

Preferably, the first pulse repetition frequency is different from the second pulse repetition frequency.

Preferably, the process further comprises the removal of clutter from the first data set and/or second data set.

The first and second data sets are preferably generated from the first and second set of signals respectively, using at least one of the group of a chirp-Z transform, a fast Fourier transform and a discrete Fourier transform.

Following the summation step, the summed signal strengths are preferably arranged in order of size and compared to the level of noise. The position of each object is preferably recorded to ensure that these positions are not used in determining the positions of further objects. This is preferably achieved by nulling the summed signal strength at known positions of the objects.

In accordance with the present invention as seen from a second aspect, there is provided a system, the system comprising processing means for performing the process of the first aspect.

The system is preferably a RADAR system and more preferably, a pulsed Doppler RADAR system. Alternatively, the system may comprise a sound navigation and ranging (SONAR) system.

The present invention will now be described by way of example only, and with reference to the accompanying drawings, in which:

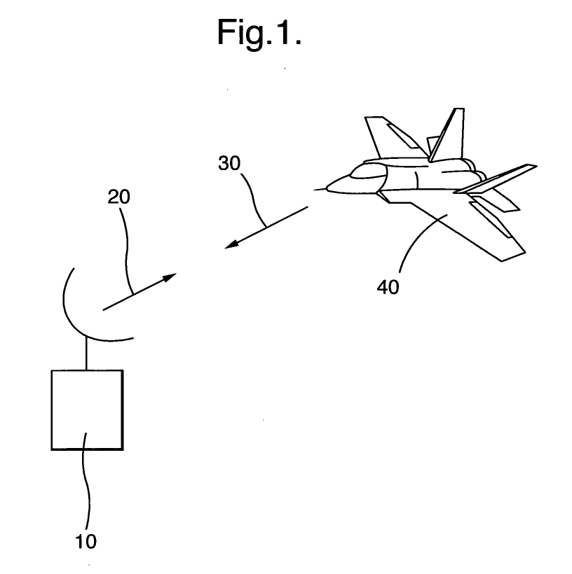

FIG. 1 is a schematic illustration of a RADAR system;

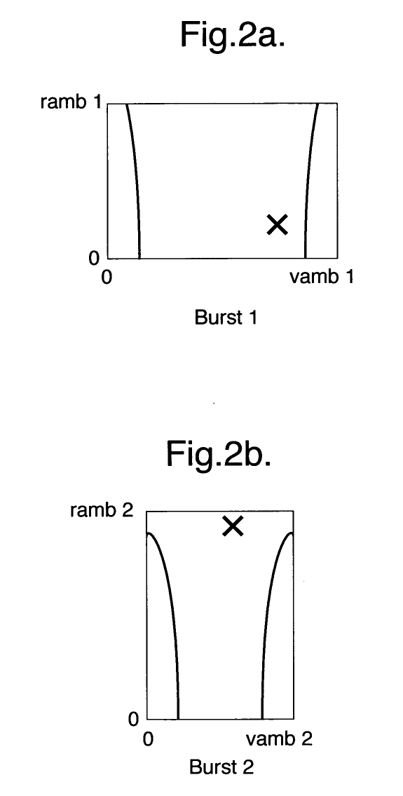

FIG. 2a is a range-velocity map for a first burst of pulses transmitted at a first pulse repetition frequency (PRF);

FIG. 2b is a range-velocity map for a second burst of pulses transmitted at a second PRF;

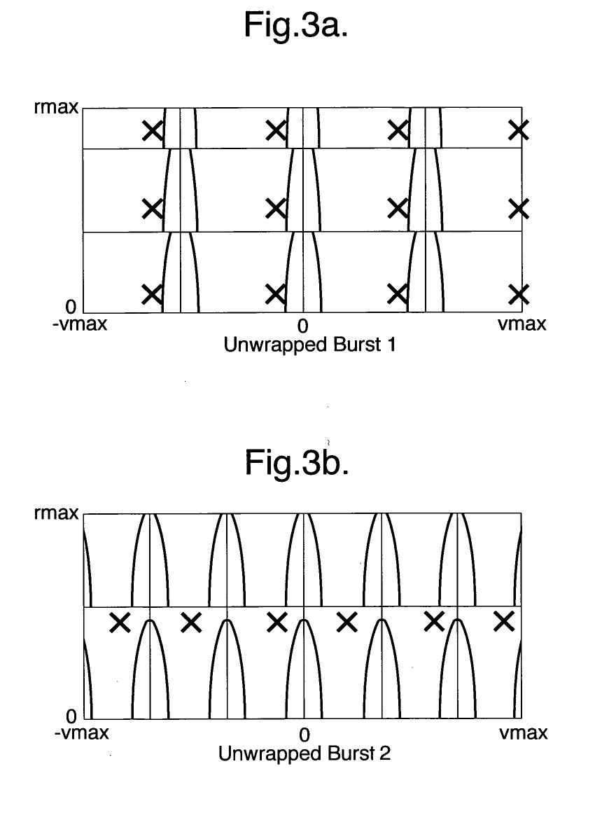

FIG. 3a is a range-velocity map of FIG. 2a unwrapped to extend the range and velocity;

FIG. 3b is a range-velocity map of FIG. 2b unwrapped to extend the range and velocity; and,

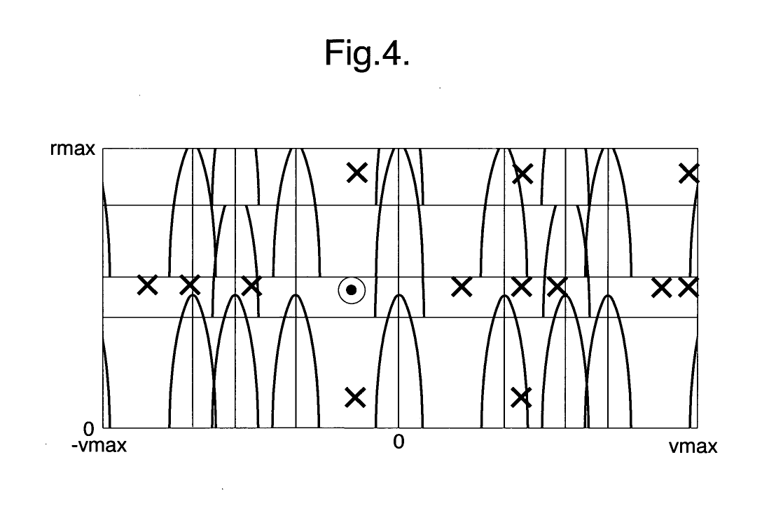

FIG. 4 is a combined range-velocity map generated by summing FIGS. 3a and 3b.

According to a first embodiment of the present invention, the process proceeds by determining range-velocity maps for each burst of pulses generated by a pulsed Doppler RADAR system 10. A pulse 20 is transmitted from the RADAR system 10 as shown in FIG. 1 of the drawings and the reflected signal 30 is detected in determining a range and velocity of an object, such as a ship or aeroplane 40. The pulses from each burst are generated using different pulse repetition frequencies (PRF) and the range-velocity maps are generated by applying a chirp-Z transform to the received signals. The use of the chirp-Z transform enables velocity spacing to be the same for all of the maps by compensating for different pulse repetition times (PRT) and number of pulses for each burst.

By way of example, the typical range-velocity maps for two bursts of pulses each having different PRF are shown in FIGS. 2a and 2b, respectively. In practice however, at least three bursts are used to ensure accurate resolution of the ambiguities. Referring to FIG. 2, ramb1 and ramb2 represent an ambiguous range for each of the first and second bursts respectively, and vamb1 and vamb2 represent corresponding first and second ambiguous velocities respectively. The range-velocity maps are essentially 3-dimensional plots with the third coordinate value being representative of a signal strength, i.e. power, reflected from the particular range-velocity position.

Grey side bands are shown in each map corresponding to signals reflected from clutter regions. A position and corresponding velocity of an object, such as a ship or aircraft 40 is represented by a cross. The two maps are of different size owing to the differences in PRF. The reason that the object does not appear in the same place in FIGS. 2a and 2b is that the object is in the second range ambiguity of the first burst and has a negative velocity in the first negative ambiguity of the first burst.

Using pattern recognition techniques, the clutter is then removed. This step effectively identifies the grey parts of the maps shown in FIGS. 2a and 2b and removes the data by zeroing the signal strength at these particular range-velocity coordinates. The maps are then further processed to identify the range-velocity coordinates of any objects and subsequently, to remove the representation of the objects from the maps by zeroing the signal strength at these range-velocity coordinates. At this stage, the objects that require extra gain to differentiate them from the noise, namely those below or near to the noise threshold, will not be detected. The removal of the larger signal strengths at this stage negates the need to remove their “ghosts” in other ambiguities, later. If they were left in at this stage, then it would be possible to use the process as hereinafter described to help deduce their positions in absolute range and velocity.

According to a second embodiment of the invention, it is possible to remove the clutter by comparing signal strengths at corresponding range-velocity coordinates of each respective map, and then determining those coordinates on one map for which the reflected signal strength is significantly higher than at the corresponding coordinate on the other map. Such a process could even be used in addition to removing clutter on a single burst basis. However, it would be necessary to exclude maps from the comparison if the cell in question has already been zeroed or nulled. This comparison process identifies all the ambiguous clutter and leaves the non-ambiguous clutter in place. In this process, clutter is only identified if it exists on all maps at a particular unwrapped location.

According to a third embodiment of the invention, the unambiguous clutter is retained within the maps. The signal corresponding to clutter has noise like properties. As such, the sum of the signal strengths at corresponding range-velocity coordinates on the maps will decorrelate over time. It is likely however that between bursts, even with a small change in transmission frequency, the correlation will be high and so the effect will be small. Nevertheless, this will improve the object to clutter signal ratio.

Removal of ambiguous reflections by comparing the signal strengths at corresponding positions on each map will adversely effect the detectability of objects that fade from one burst to another. For this reason, it is also necessary to incorporate the process of the first embodiment, namely the single burst detection process. If objects significantly fade between bursts, then the summing process as described above is less appropriate as the faded target will produce added noise.

In detecting a moving object, the reflected signal will undergo a phase change, for example φ, with respect to the transmitted signal and this phase change is equivalent to further signals comprising a phase change of φ±2πn, where n is an integer. Accordingly, it is possible to “unwrap” the range-velocity map to extend the range and velocity values. This concept is illustrated in FIGS. 3a and 3b. A range-velocity coordinate of an object is represented with a cross and it is assumed that the strength of a signal reflected from this object is below the threshold noise level produced with a single burst. Grey areas in each figure represent range-velocity coordinates where the signal power from clutter has been zeroed.

It may be advantageous to correct or apply a correction factor to the range positions on all “unwrapped” maps in a way that is dependant on a particular cell (i.e. point on the map) position in velocity to compensate for object movement between bursts. During the time interval between bursts, the position of the moving object will change from one map to the next. The correction factor is weighted so that it has no effect at 0 velocity but has an increasing effect away from 0 velocity. To perform the correction it would be necessary to apply a phase adjustment to all range cells for a given velocity (i.e. vertically in FIG. 2). The phase adjustment in radians=(−4πfₜ×velocity of cell×time from reference burst)/(speed of light), where fₜ is the transmission frequency. In this calculation, it is assumed that time does not move during a burst, but only in steps between bursts. In this manner, “time from reference burst” will be a constant over the reference burst.

The process then proceeds by summing the signal powers from equivalent range-velocity coordinates on the maps shown in FIGS. 3a and 3b across each velocity cell. The result is illustrated in FIG. 4. Only one object position from burst 1 coincides with an object position from burst 2 and this has been illustrated by the circle. The signal power reflected from the object will sum at this particular range-velocity coordinate because of the coincidence at this point, while at other range-velocity coordinates of the object, there will be no such summation, just an accumulation of noise. Accordingly, the possibility of detection is enhanced and thus will only exist for the circled object. The circled object thus indicates the likely true range and velocity values for the object.

Once the summation has been performed, each peak, representing a region of summed signal powers, is identified and arranged in order of magnitude with the largest first. The arrangement is compared to a threshold value to take advantage of the improved signal-to-noise ratio that is present post summation. After every object has been located, i.e. the range and velocity determined, a record is then made of the associated ambiguous positions on each map to ensure that these locations are not used during the detection of further objects. Such previously detected objects would appear as ghosts. These locations are disregarded by zeroing the signal powers at the relevant range-velocity locations on the maps and then re-summing the signal powers at corresponding range-velocity coordinates on the maps to revise the combined map.

1. A process for determining the position and velocity of an object, the process comprising:
generating a first burst of pulses at a first pulse repetition frequency and subsequently receiving a first set of signals characteristic of the range and velocity of the object;
generating a second burst of pulses at a second pulse repetition frequency and subsequently receiving a second set of signals characteristic of range and velocity of the object;
generating a first data set representative of range and corresponding velocity values from the first set of signals;
generating a second data set representative of range and corresponding velocity values from the second set of signals;
summing a magnitude of a signal strength from each of the first and second data sets at corresponding range and velocity values; and,
comparing the magnitude of the summed signal strengths to a threshold value.

2. A process according to claim 1, wherein the first pulse repetition frequency is different from the second pulse repetition frequency.

3. A process according to claim 2, wherein the process further comprises the removal of clutter from the first data set and/or the second data set.

4. A process according to claim 3, wherein the first and second data sets are generated from the first and second set of signals respectively, using at least one of the group of a chirp-Z transform, a fast Fourier transform and a discrete Fourier transform.

5. A process according to claim 4, wherein the summed signal strengths are arranged in order of magnitude post summation.

6. A process according to claim 5, wherein the position of the object is recorded to ensure that the position is not used during determination of positions of subsequent objects.

7. A process according to claim 6, wherein the summed signal strength is zeroed at the position of the object to ensure that the position is not used during the determination of subsequent positions of the object.

8. A system comprising processing means for performing the process according to claim 1.

9. A system according to claim 8, wherein the system is a RADAR system.

10. A system according to claim 9, wherein the system is a pulsed Doppler RADAR system.

11. A system according to claim 8, wherein the system is a sound navigation and ranging (SONAR) system.

12. (canceled)

13. (canceled)
